(19) United States
(12) Patent Application Publication
(10) Pub. No.: US 2015/0301994 A1
(43) Pub. Date: Oct. 22, 2015

(54) NON-TRANSITORY COMPUTER READABLE MEDIUM, INFORMATION PROCESSING APPARATUS, AND INFORMATION PROCESSING METHOD

(71) Applicant: FUJI XEROX CO., LTD., Tokyo (JP)

(72) Inventor: Saneyuki KOBAYASHI, Kanagawa (JP)

(73) Assignee: FUJI XEROX CO., LTD., Tokyo (JP)

(21) Appl. No.: 14/665,167

(22) Filed: Mar. 23, 2015

(30) Foreign Application Priority Data
Apr. 16, 2014 (JP) 2014-084769

(51) Int. Cl. G06F 17/22; G06F 17/30

(52) U.S. Cl. CPC G06F 17/2288; G06F 17/2247; G06F 17/30011

(57) ABSTRACT

A non-transitory computer readable medium stores a program causing a computer to execute a process, the process including: acquiring plural designated successive versions of structured document information; extracting differences between previous and subsequent versions of the acquired structured document information; determining collections of differences with a common element name, of the extracted differences, as working ranges; and generating difference information by summarizing, of the working ranges, working ranges that match a condition determined in advance by omitting the differences included in such working ranges.

### CROSS-REFERENCE TO RELATED APPLICATIONS

This application is based on and claims priority under 35 USC 119 from Japanese Patent Application No. 2014-084769 filed Apr. 16, 2014.

### BACKGROUND

### Technical Field

The present invention relates to a non-transitory computer readable medium, an information processing apparatus, and an information processing method.

### SUMMARY

According to an aspect of the present invention, there is provided a non-transitory computer readable medium storing a program causing a computer to execute a process. the process includes: acquiring plural designated successive versions of structured document information; extracting differences between previous and subsequent versions of the acquired structured document information; determining collections of differences with a common element name, of the extracted differences, as working ranges; and generating difference information by summarizing, of the working ranges, working ranges that match a condition determined in advance by omitting the differences included in such working ranges.

### BRIEF DESCRIPTION OF THE DRAWINGS

Exemplary embodiments of the present invention will be described in detail based on the following figures, wherein:

FIG. 1 is a block diagram illustrating an example of the configuration of an information processing apparatus according to a first exemplary embodiment;

FIG. 2 is a schematic diagram illustrating an example of the configuration of XML document information;

FIG. 3 illustrates basic operation;

FIG. 4 is a schematic diagram illustrating an example of the configuration of a difference;

FIGS. 5A to 5C are each a schematic diagram illustrating an example of operation for determining a working range;

FIG. 6 is a schematic diagram illustrating an example of the configuration of difference information;

FIG. 7 illustrates operation for displaying the difference information;

FIG. 8 is a flowchart illustrating an example of operation of the information processing apparatus;

FIG. 9 is a block diagram illustrating an example of the configuration of an information processing apparatus according to a second exemplary embodiment;

FIG. 10 is a schematic diagram illustrating the configuration of a keyword reception display screen;

FIG. 11 is a schematic diagram illustrating an example of operation for a keyword search through a difference;

FIG. 12 is a schematic diagram illustrating another example of the configuration of the difference information;

FIG. 13 illustrates operation for displaying the difference information; and

FIG. 14 is a flowchart illustrating an example of operation of the information processing apparatus.

### DETAILED DESCRIPTION

### First Exemplary Embodiment

### (Configuration of Information Processing Apparatus)

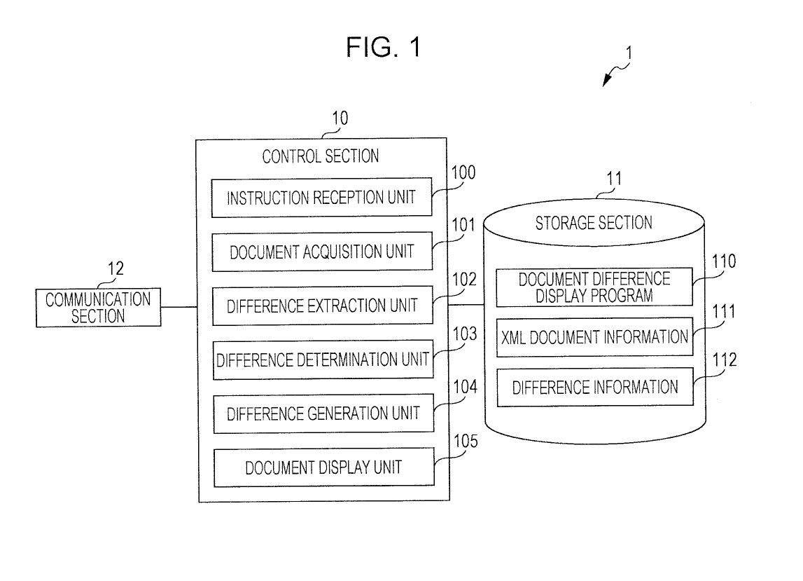

FIG. 1 is a block diagram illustrating an example of the configuration of an information processing apparatus according to a first exemplary embodiment.

An information processing apparatus 1 handles XML (Extensible Markup Language) document information as an example of a structured document. The information processing apparatus 1 prepares a new version of the XML document information each time the XML document information is edited, and prepares a difference between plural previously and subsequently prepared versions of the XML document information as difference information. The term “structured document” refers to a document having texts as elements and names (element names) such as “topic” and “title” attached to the elements for identification of the type of the elements, and having plural elements arranged in a tree structure, for example. The “difference” includes at least locations of difference in the XML document information, contents of change, and version information.

The information processing apparatus 1 includes a control section 10 constituted of a central processing unit (CPU) or the like to control various sections and execute various programs, a storage section 11 constituted of a storage medium such as a flash memory to store information, and a communication section 12 that communicates with the outside via a network.

The control section 10 executes a document difference display program 110 to be discussed later to function as an instruction reception unit 100, a document acquisition unit 101, a difference extraction unit 102, a difference determination unit 103, a difference generation unit 104, a document display unit 105, and so forth.

The instruction reception unit 100 receives a generation instruction for difference information from a user who uses an external terminal device connected via the communication section 12. The generation instruction includes designation of information such as XML document information 111 to be processed, locations of difference, and so forth.

The document acquisition unit 101 acquires all versions of the XML document information 111 to be processed from the storage section 11 when the instruction reception unit 100 receives the generation instruction for difference information.

The difference extraction unit 102 extracts differences between previous and subsequent versions of the XML document information 111.

The difference determination unit 103 determines working ranges of the differences extracted by the difference extraction unit 102. The term “working range” refers to a range in which it is assumed that the differences have a common working content, and to a collection of differences with contents of change having a common element name. The boundary between the working ranges is determined by locations at which the element name is varied.

The difference generation unit 104 generates difference information 112 by summarizing, or not summarizing, the differences extracted by the difference extraction unit 102 for each of the working ranges determined by the difference determination unit 103, and stores the difference information 112 in the storage section 11.

The document display unit 105 displays the XML document information 111 and/or the difference information 112 on a display section or the like of the external terminal device connected via the communication section 12.

The storage section 11 stores the document difference display program 110 which causes the control section 10 to operate as the units 100 to 105 discussed above, the XML document information 111, the difference information 112, and so forth.

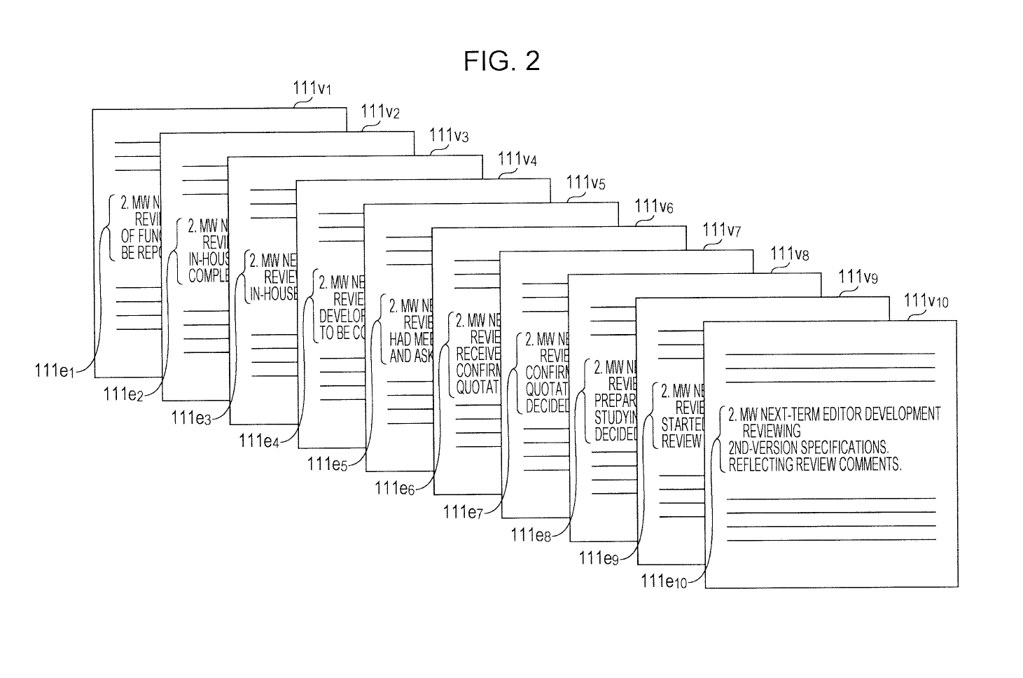

FIG. 2 is a schematic diagram illustrating an example of the configuration of the XML document information 111.

The XML document information 111 includes previous versions 1 to 9 of XML document information 111v₁ to 111v₉, and a current version 10 of XML document information 111v₁₀, for example. In addition, the versions of the XML document information 111v₁ to 111v₁₀ include elements 111e₁ to 111e₁₀, respectively, and contents of change (and locations of difference and version information) between the elements 111e₁ to 111e₁₀ correspond to differences from the previous version.

(Operation of Information Processing Apparatus)

Next, the function of the first exemplary embodiment will be described in regard to (1) basic operation, (2) difference information generation operation, and (3) difference information display operation.

(1) Basic Operation

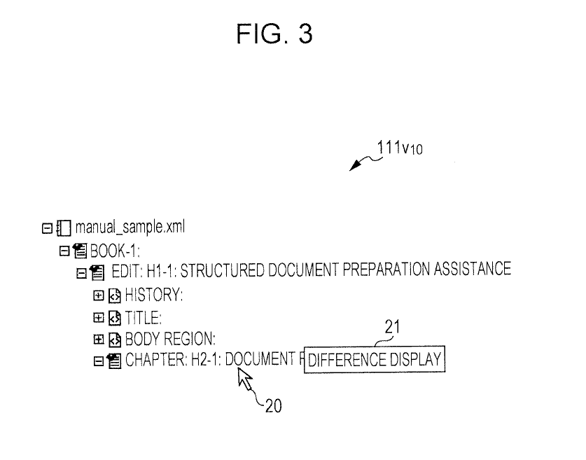

FIG. 3 illustrates basic operation.

In the XML document information 111v₁₀, as illustrated in FIG. 3, the elements are arranged in a tree structure, and such an arrangement is displayed on the display section of the external terminal device. “manual_sample.xml” corresponds to the XML document information 111v₁₀, which includes a single or plural elements with an element name “Book”. “Book-1” includes an element with an element name “Edit: H1-1: Structured document preparation assistance”.

“Edit: H1-1: Structured document preparation assistance” includes elements “History”, “Title”, “Body region”, and “Chapter: H2-1: Document preparation method” at the same level.

The user of the terminal device operates the terminal device to select an element with an element name “Chapter: H2-1: Document preparation method” using a cursor 20, for example, to display a menu 21 for displaying a difference for the element.

Next, the user of the terminal device selects the menu 21 using the cursor 20 to request difference display. In the case where there is no corresponding difference information in the information processing apparatus 1, the request is transmitted from the terminal device to the information processing apparatus 1 as a generation instruction for difference information and a display instruction for difference information.

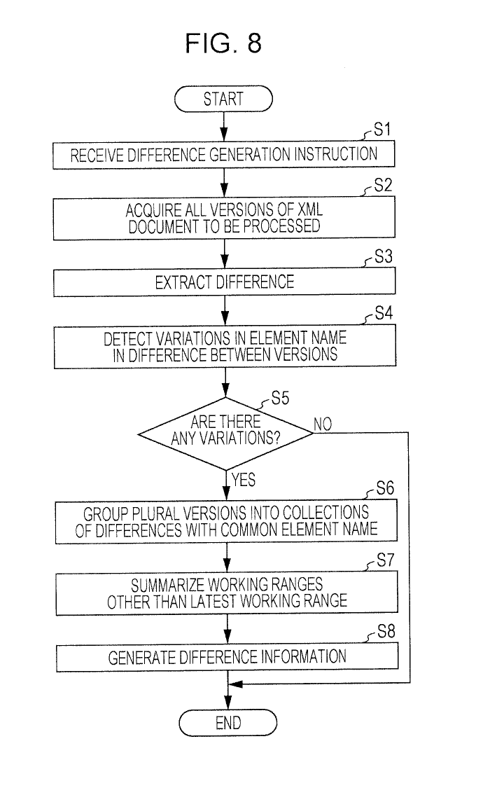

FIG. 8 is a flowchart illustrating an example of operation of the information processing apparatus 1.

The instruction reception unit 100 of the information processing apparatus 1 receives a generation instruction for difference information from an external terminal device via the communication section 12 (S1).

Next, when the instruction reception unit 100 receives the generation instruction for difference information, the document acquisition unit 101 acquires all versions of the XML document information 111v₁ to 111v₁₀ to be processed from the storage section 11 as illustrated in FIG. 2 (S2).

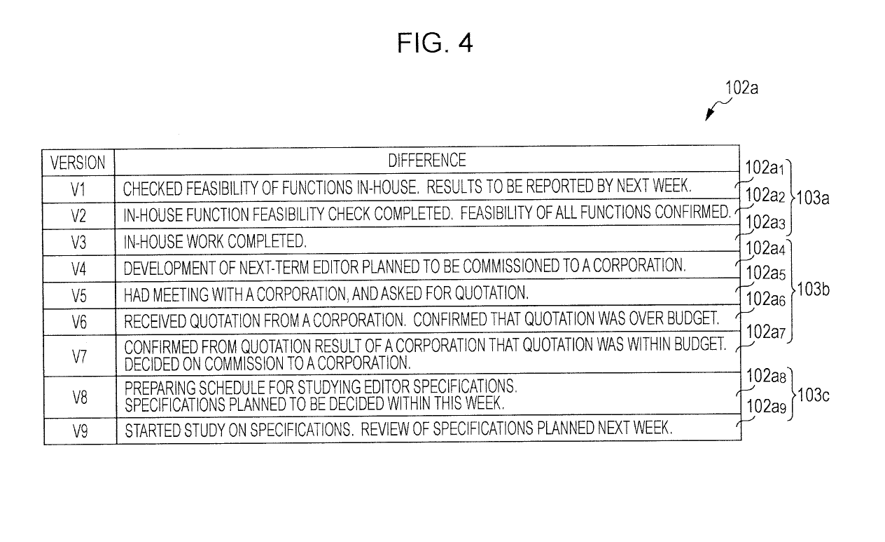

Next, as illustrated in FIG. 4, the difference extraction unit 102 extracts a difference 102a between the versions of the XML document information 111v₁ to 111v₁₀ (S3).

FIG. 4 is a schematic diagram illustrating an example of the configuration of the difference.

The difference 102a includes differences 102a₁ to 102a₁₀ obtained by extracting the contents of change and the version information between the elements 111e₁ to 111e₁₀ of the XML document information 111v₁ to 111v₁₀ illustrated in FIG. 2 as differences from previous versions.

(2) Difference Information Generation Operation

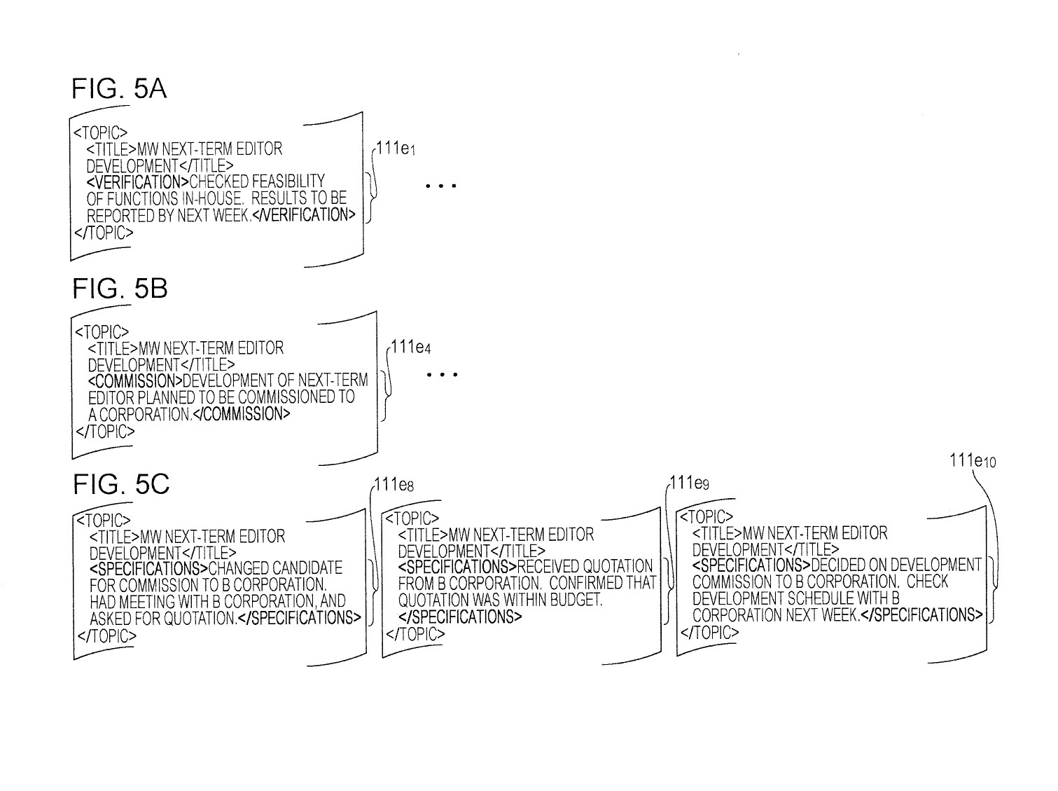

Next, as illustrated in FIG. 5, the difference determination unit 103 detects variations in element name in the differences (S4), and groups the elements into collections of differences with a common element name using locations of the variations (S5: Yes) as the boundary between the working ranges (S6).

FIGS. 5A to 5C are each a schematic diagram illustrating an example of operation for determining a working range.

As illustrated in FIG. 5A, the elements 111e₁ to 111e₃ have a common element name “Verification”. As illustrated in FIG. 5B, in addition, the elements 111e₄ to 111e₇ have an element name “Commission”, which has been varied from the element name “Verification” of the elements 111e₁ to 111e₃. As illustrated in FIG. 5C, further, the elements 111e₈ to 111e₁₀ have an element name “Specifications”, which has been varied from the element name “Commission” of the elements 111e₄ to 111e₇.

That is, the difference determination unit 103 detects variations in element name in the differences between the elements 111e₃ and 111e₄ and between the elements 111e₇ and 111e₈, and groups the elements 111e₁ to 111e₃, the elements 111e₄ to 111e₇, and the elements 111e₈ to 111e₁₀, which are collections of differences, to define working ranges 103a, 103b, and 103c as illustrated in FIG. 4.

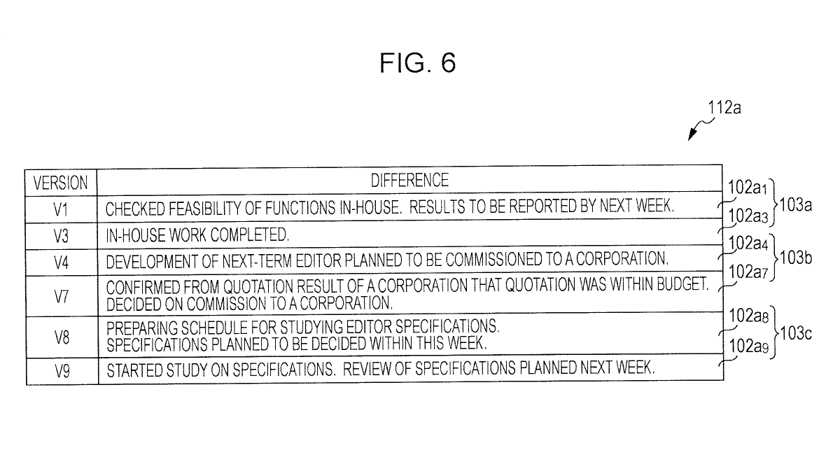

Next, as illustrated in FIG. 6, the difference generation unit 104 summarizes the differences for working ranges other than the latest working range and does not summarize the latest working range (S7) to generate difference information 112a (S8), and stores the difference information 112a in the storage section 11.

FIG. 6 is a schematic diagram illustrating an example of the configuration of the difference information 112.

The difference information 112a is generated by summarizing the working ranges 103a and 103b, of the difference 102a illustrated in FIG. 4, and not summarizing the working range 103c. That is, differences other than the first and last differences, namely the difference 102a₂ and the differences 102a₅ and 102a₆, are omitted from the working ranges 103a and 103b, respectively, and no differences are omitted from the working range 103c.

The summarization method described above is exemplary, and a combination of differences to be deleted from working ranges may be set as desired. In the case where the number of differences after summarizing differences from working ranges other than the latest working range is larger than a number determined in advance, in addition, further differences may be omitted. In addition, the latest working range may also be summarized.

(3) Difference Information Display Operation

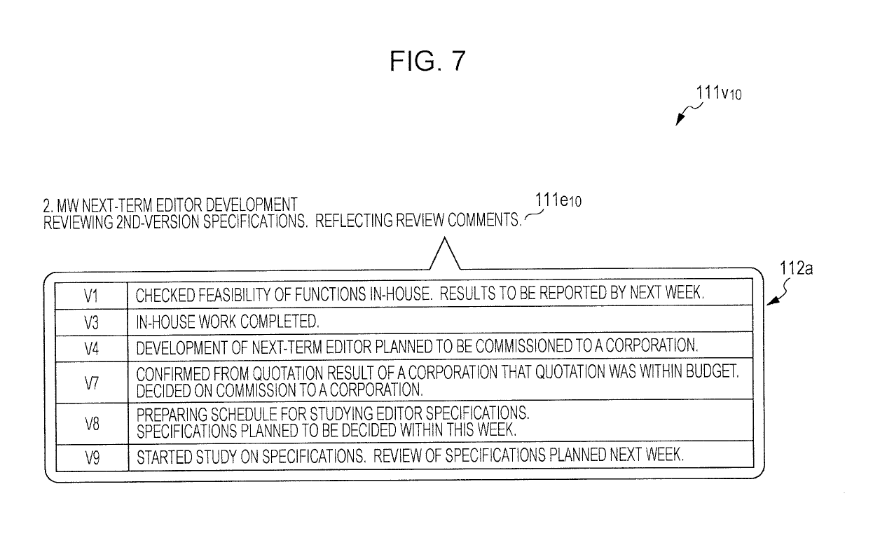

Next, as illustrated in FIG. 7, the document display unit 105 displays the XML document information 111v₁₀ and the difference information 112a on the display section of the external terminal device.

FIG. 7 illustrates operation for displaying the difference information 112.

The difference information 112a is displayed on the display section of the external terminal device so as to point to the location of difference of the XML document information 111v₁₀.

### Second Exemplary Embodiment

### (Configuration of Information Processing Apparatus)

In a second exemplary embodiment, a keyword search unit 106 is added to the configuration according to the first exemplary embodiment, and differences including a keyword when summarizing working ranges are not omitted but included in the difference information 112. In the following, components that are common to those according to the first exemplary embodiment are denoted by the same reference numerals.

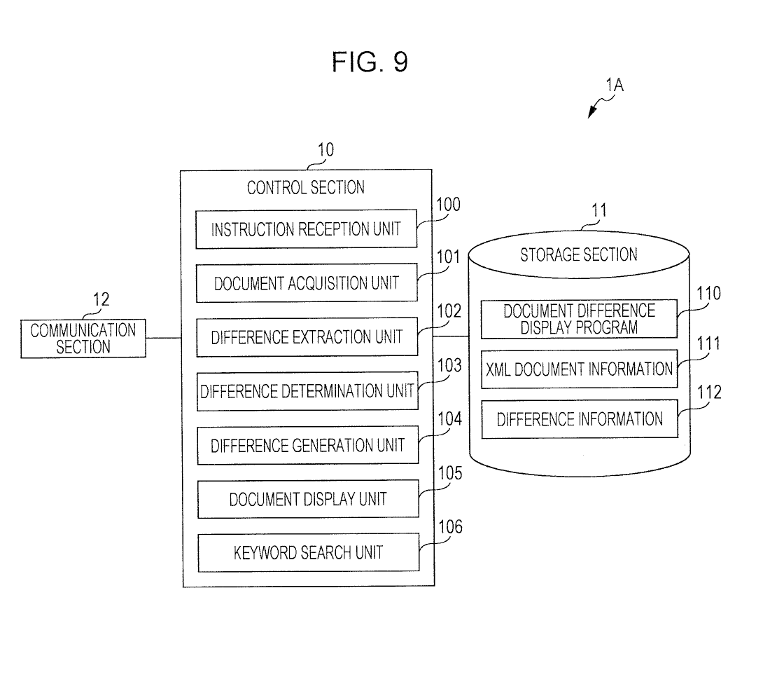

FIG. 9 is a block diagram illustrating an example of the configuration of an information processing apparatus according to the second exemplary embodiment.

An information processing apparatus 1A is prepared by adding a keyword search unit 106 to the information processing apparatus 1 according to the first exemplary embodiment.

The keyword search unit 106 receives a keyword input to the external terminal device, and searches the differences extracted by the difference extraction unit 102 to find a text including the received keyword.

### (Operation of Information Processing Apparatus)

Next, the function of the second exemplary embodiment will be described in regard to (1) basic operation, (2) difference information generation operation, and (3) difference information display operation.

(1) Basic Operation

As in the first exemplary embodiment, as illustrated in FIG. 3, the user of the terminal device operates the terminal device to select an element with an element name “Chapter: H2-1: Document preparation method” using a cursor 20, for example, to display a menu 21 for displaying a difference.

Next, the user of the terminal device selects the menu 21 using the cursor 20 to request difference display.

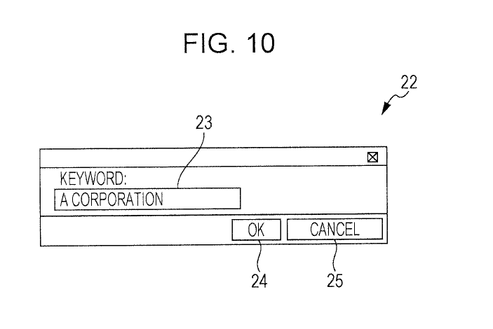

When the request for difference display is received, the information processing apparatus 1A displays a keyword reception display screen 22 on the display section of the external terminal device as illustrated in FIG. 10.

FIG. 10 is a schematic diagram illustrating the configuration of the keyword reception display screen 22.

The keyword reception display screen 22 includes an input field 23 for receiving input of a keyword, a button 24 for requesting a search using the keyword input to the input field 23, and a button 25 for canceling a search request.

The user of the terminal device operates the terminal device to input “A Corporation” to the input field 23 as an example of the keyword, and operates the button 24 to request a search.

The terminal device transmits a search request to the information processing apparatus 1A together with the keyword “A Corporation”.

In the case where there is no corresponding difference information in the information processing apparatus 1A, the request is transmitted from the terminal device to the information processing apparatus 1A as a generation instruction for difference information and a display instruction for difference information.

(2) Difference Information Generation Operation

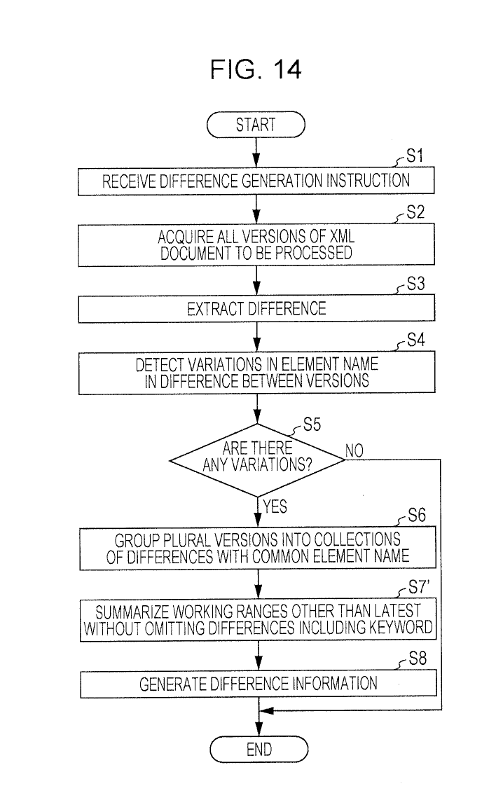

FIG. 14 is a flowchart illustrating an example of operation of the information processing apparatus 1A.

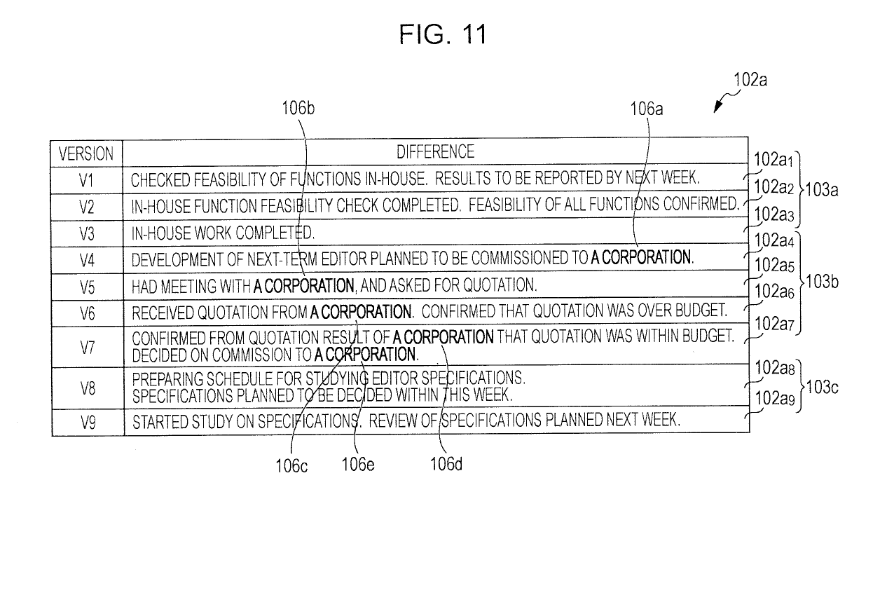

The information processing apparatus 1A executes steps S1 to S3 illustrated in the flowchart of FIG. 14 as in the first exemplary embodiment to extract a difference 102a illustrated in FIG. 11. In the flowchart of FIG. 14, only step S7′ is different from its counterpart in the flowchart illustrated in FIG. 8.

FIG. 11 is a schematic diagram illustrating an example of operation for a keyword search through the difference 102a.

The difference 102a is the same as the difference 102a illustrated in FIG. 4. The keyword search unit 106 receives a keyword “A Corporation”, and searches the difference 102a to find a text including “A Corporation”. As a result, as illustrated in FIG. 11, a keyword 106a is found in the difference 102a₄, a keyword 106b is found in the difference 102a₅, a keyword 106c is found in the difference 102a₆, and keywords 106d and 106e are found in the difference 102a₇.

Next, the information processing apparatus 1A executes steps S4 to S6 as in the first exemplary embodiment, and the difference determination unit 103 detects variations in element name in the differences, and groups the elements into working ranges 103a to 103c using locations of the variations as the boundary between the working ranges.

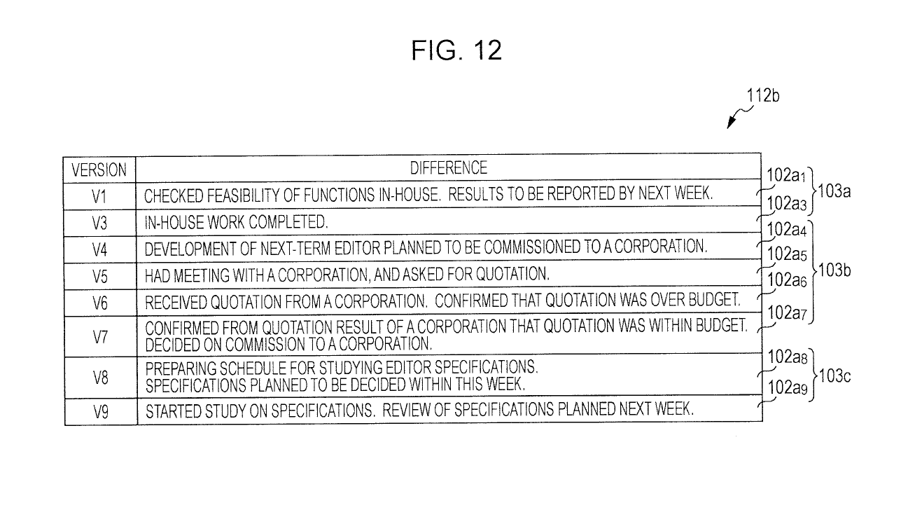

Next, as illustrated in FIG. 12, the difference generation unit 104 summarizes the differences for working ranges other than the latest working range without omitting the differences including the keyword “A Corporation” and does not summarize the latest working range (S7′), and generates difference information 112b (S8) to store the difference information 112b in the storage section 11.

FIG. 12 is a schematic diagram illustrating another example of the configuration of the difference information 112.

The difference information 112b is generated by summarizing the working range 103a without omitting the differences 102a₄ to 102a₇ including the keyword “A Company”, of the difference 102a illustrated in FIG. 11, and not summarizing the latest working range 103c. That is, differences other than the first and last differences, namely the difference 102a₂, are omitted from the working range 103a, and no differences are omitted from the working ranges 103b and 103c.

(3) Difference Information Display Operation

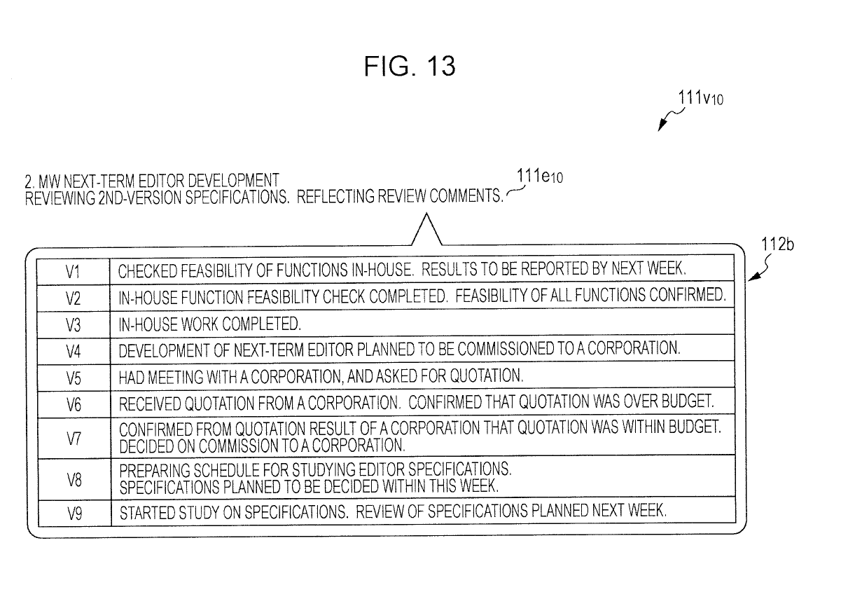

Next, as illustrated in FIG. 13, the document display unit 105 displays the XML document information 111v₁₀ and the difference information 112b on the display section of the external terminal device.

FIG. 13 illustrates operation for displaying the difference information 112b.

The difference information 112b is displayed on the display section of the external terminal device so as to point to the location of difference of the XML document information 111v₁₀.

### Other Embodiments

The present invention is not limited to the exemplary embodiments described above, and may be modified in various ways without departing from the scope and spirit of the present invention.

In the exemplary embodiments described above, the functions of the units 100 to 106 of the control section 10 are implemented by a program. However, all or a part of the units may be implemented by hardware such as an application specific integrated circuit (ASIC). In addition, the program used in the exemplary embodiments described above may be provided as stored in a recording medium such as a CD-ROM. In addition, the steps described in relation to the exemplary embodiments described above may be replaced, deleted, added, etc. without departing from the scope and spirit of the present invention.

What is claimed is:

1. A non-transitory computer readable medium storing a program causing a computer to execute a process, the process comprising:
acquiring a plurality of designated successive versions of structured document information;
extracting differences between previous and subsequent versions of the acquired structured document information;
determining collections of differences with a common element name, of the extracted differences, as working ranges; and
generating difference information by summarizing, of the working ranges, working ranges that match a condition determined in advance by omitting the differences included in such working ranges.

2. An information processing apparatus comprising:
a document acquisition unit that acquires a plurality of designated successive versions of structured document information;
a difference extraction unit that extracts differences between previous and subsequent versions of the structured document information acquired by the document acquisition unit;
a difference determination unit that determines collections of differences with a common element name, of the differences extracted by the difference extraction unit, as working ranges; and
a generation unit that generates difference information by summarizing, of the working ranges, working ranges that match a condition determined in advance by omitting the differences included in such working ranges.

3. The information processing apparatus according to claim 2,
wherein the computer is caused to further function as a search unit that receives a keyword and searches the differences extracted by the difference extraction unit to find differences including the received keyword, and
the difference generation unit generates the difference information without omitting the differences including the keyword found by the search unit.

4. The information processing apparatus according to claim 2,
wherein the difference generation unit summarizes, of the working ranges, working ranges other than a latest working range.

5. The information processing apparatus according to claim 2,
wherein the difference generation unit further summarizes the difference information in a case where a number of differences included in the difference information is larger than a number determined in advance.

6. An information processing method comprising:
acquiring a plurality of designated successive versions of structured document information;
extracting differences between previous and subsequent versions of the acquired structured document information;
determining collections of differences with a common element name, of the extracted differences, as working ranges; and
generating difference information by summarizing, of the working ranges, working ranges that match a condition determined in advance by omitting the differences included in such working ranges.
